(19) United States
(12) Patent Application Publication
(10) Pub. No.: US 2013/0179818 A1
(43) Pub. Date: Jul. 11, 2013

(54) COMMUNICATION DEVICE, METHOD, AND INTERFACE FOR EMERGENCY RESPONDER

(71) Applicants: Shih-Cheng WANG, Tu-Cheng (TW); Yi-Wen CAI, Tu-Cheng (TW)

(72) Inventors: Shih-Cheng WANG, Tu-Cheng (TW); Yi-Wen CAI, Tu-Cheng (TW)

(73) Assignee: HON HAI PRECISION INDUSTRY CO., LTD., Tu-Cheng (TW)

(21) Appl. No.: 13/347,783

(22) Filed: Jan. 11, 2012

(51) Int. Cl. G06F 3/048

(52) U.S. Cl. 715/771

(57) ABSTRACT

A communication device is provided. The communication device includes software modules include instructions: to display a floor plan diagram corresponding to a scene on a screen display; to display a personnel symbol on the floor plan diagram according to the location of the communication device; to display an equipment symbol on the floor plan diagram according to an equipment location information received from a command assignment system; to display a report interface and an intercommunication interface on the screen display; to transmit a report message for interacting with a command assignment interface of the command assignment system in response to detecting a submission operation with respect to the report interface; and to transmit a message for interacting with a communication interface of a neighboring communication device in response to detecting a submission operation with respect to the intercommunication interface.

The disclosure further provides a communication method and a communication interface.

### BACKGROUND

1. Technical Field

The present disclosure relates to a communication device, a communication method, and a communication interface, and particularly to a communication device, a communication method, and a communication interface for a responder of an emergency to interact with a graphical user interface of a command assignment device.

2. Description of Related Art

In an emergency, a responder to the scene of the emergency usually uses a public safety radio to communicate with a commander. However, the responder may be incapable of comprehending the commands of the commander effectively and precisely because of inexperience or the confusing nature of some emergency situations, especially when the responder is unfamiliar with the scene.

Thus, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a responder device of the present disclosure.

FIG. 2 is a flowchart of a first embodiment of a communication method implemented through the responder device of FIG. 1.

FIGS. 3A/3B is a flowchart of a second embodiment of a communication method implemented through the responder device of FIG. 1.

FIG. 4 is a flowchart of a third embodiment of a communication method implemented through the responder device of FIG. 1.

FIG. 5 is a flowchart of a fourth embodiment of a communication method implemented through the responder device of FIG. 1.

FIG. 6 is a schematic view of an embodiment of a user interface 1000 implemented through the responder device of FIG. 1.

FIG. 7 is a schematic view of an embodiment of a process of using the user interface of FIG. 6 in mission mode.

FIG. 8A is a schematic view of a first embodiment of a process of using the user interface of FIG. 6 in communication mode.

FIG. 8B is a schematic view of a second embodiment of a process of using the user interface of FIG. 6 in communication mode.

FIG. 9 is a schematic view of an embodiment of a process of using the user interface of FIG. 6 in scene mode.

### DETAILED DESCRIPTION

In general, the disclosure relates to communication interfaces, electronic devices with a communication interface, and methods for operating communication interfaces. The invention is particularly suitable for use with electronic devices with a touch-sensitive display.

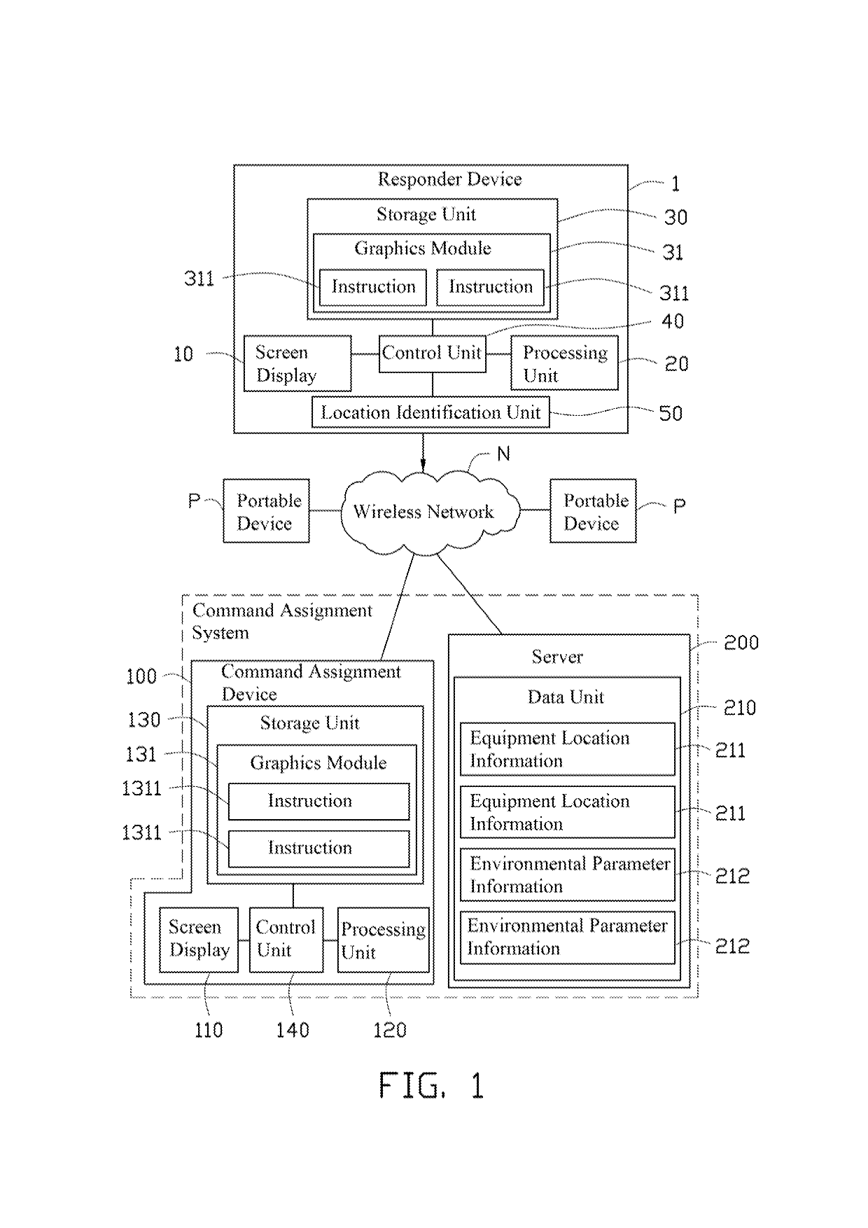

FIG. 1 is a block diagram of an embodiment of a responder device 1 of the present disclosure. The responder device 1 is a portable device such as a tablet computer, a smart phone, or a public safety radio. The responder device 1 is capable of interacting with a command assignment system S and neighboring portable devices P through a wireless network N implemented according to a telecommunication standard such as WI-FI or BLUETOOTH, thereby communicating with a command assignment device 100 and a server 200 of the command assignment system S. The responder device 1 transmits a responder device location information Ir (not shown) of the responder device 1 to the server 200, and receives equipment location information 211 of equipment such as water hydrants located in a particular place or location (particular scene) from a data unit 210 of the server 200.

The responder device 1 includes a screen display 10, a processing unit 20, a storage unit 30, a control unit 40, and a location identification unit 50. In the illustrated embodiment, the screen display 10 is a touch-sensitive display. In other embodiments, the screen display 10 may be another type of electronic visual display such as a liquid crystal display (LCD) or an electronic paper display. The processing unit 20 may include a central processing unit (CPU), which communicates with the screen display 10, the storage unit 30, and the location identification unit 50 via the control unit 40. The storage unit 30 may include a high speed random access memory and may also include non-volatile memory, which stores a graphics module 31 available to the processing unit 20. The graphics module 31 includes instructions 311 for implementing functions relating to one or more graphical user interfaces (GUIs). The control unit 40 may include controller devices including memory controllers, peripheral device interfaces, and I/O subsystems. In the illustrated embodiment, the location identification unit 50 is a Global Positioning System (GPS) receiver, which produces the responder device location information Ir including a latitude, a longitude, and an elevation of the responder device 1. In other embodiments, the location identification unit 50 may be other types of devices such as Wi-Fi Positioning System (WPS) receiver, while the responder device location information Ir may include other types of location related parameters of the responder device 1. In the illustrated embodiment, the neighboring portable devices P are the same type of devices as the responder device 1.

The command assignment device 100 receives the responder device location information Ir from the server 200. In the illustrated embodiment, the command assignment device 100 includes a screen display 110, a processing unit 120, a storage unit 130, and a control unit 140. The screen display 110 is a touch-sensitive display. The processing unit 120 communicates with the screen display 110 and the storage unit 130 via the control unit 140. The storage unit 130 stores a graphics module 131 available to the processing unit 120. The graphics module 131 includes instructions 1311 for implementing GUI related functions. The command assignment device 100 is a portable device such as a tablet computer, a smart phone, or a public safety radio. In other embodiments, the command assignment device 100 may be a stationary device such as a desktop personal computer, and the screen display 110 can be another type of electronic visual display such as a LCD or an electronic paper display.

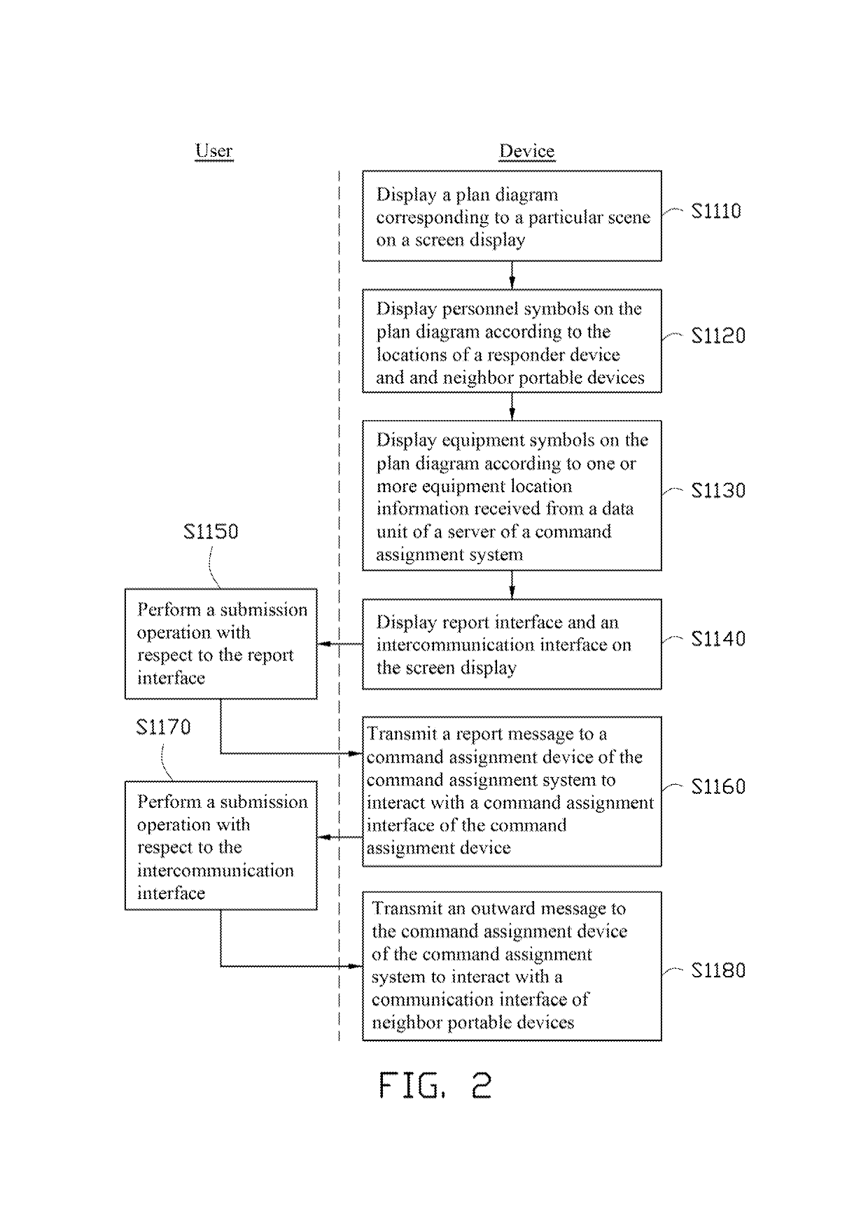

FIG. 2 is a flowchart of a first embodiment of a communication method implemented through the responder device 1 of FIG. 1. The communication method of the present disclosure is as follows. The steps are implemented through the instructions 311 stored in the graphics module 31 of the storage unit 30. Depending on the embodiment, additional steps may be added, others removed, and the ordering of the steps may be changed.

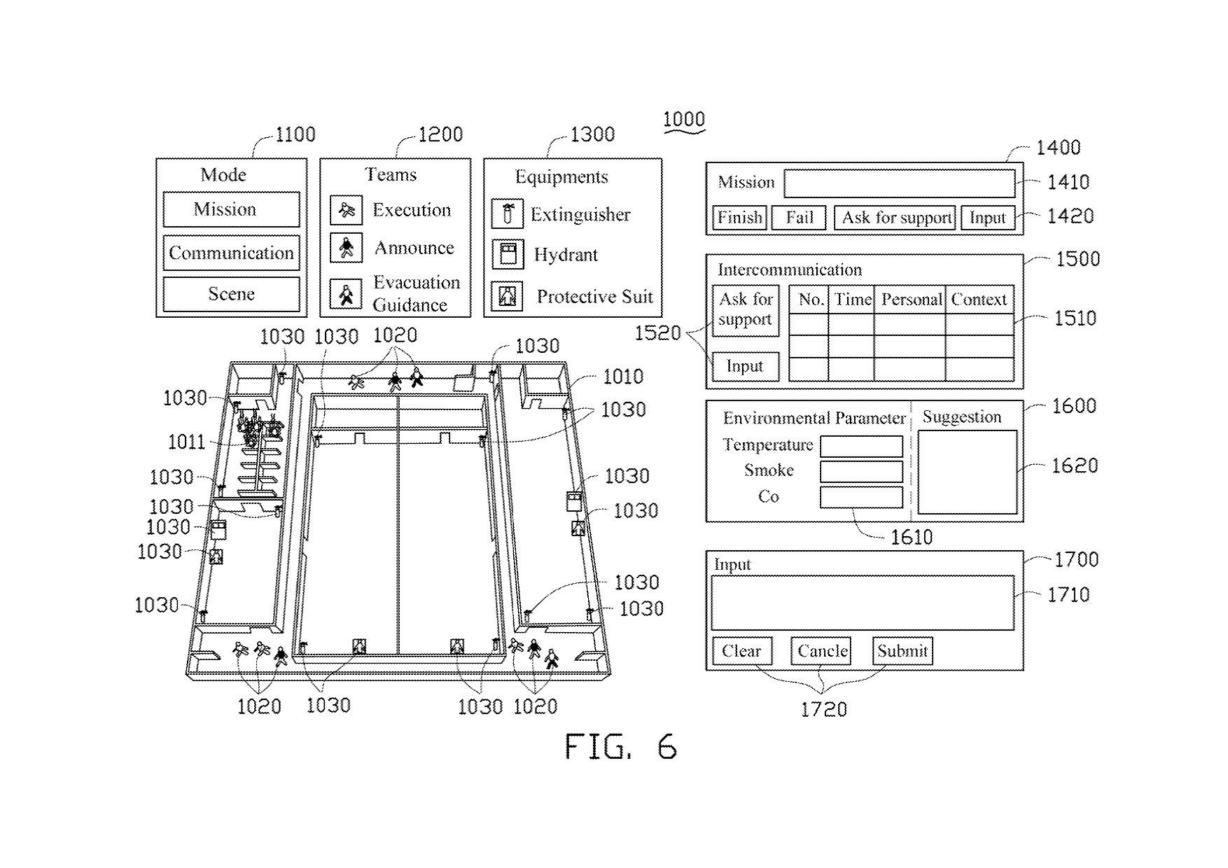

In step S1110, a floor plan diagram 1010 (see FIG. 6) corresponding to the particular scene is displayed on the screen display 10.

In step S1120, personnel symbols 1020 (see FIG. 6) are displayed on the floor plan diagram 1010 according to the locations of the responder device 1 and the neighboring portable devices P, if any.

In step S1130, equipment symbols 1030 (see FIG. 6) are displayed on the floor plan diagram 1010 according to the equipment location information 211 received from the data unit 210 of the server 200 of the command assignment system S.

In step S1140, a report interface 1400 (see FIG. 6) and an intercommunication interface 1500 (see FIG. 6) are displayed on the screen display 10.

In step S1150, the user of the responder device 1 performs a submission operation with respect to the report interface 1400.

In step S1160, a report message is transmitted to the command assignment device 100 of the command assignment system S, thereby interacting with a command assignment interface A (not shown) displayed on the screen display 110 of the command assignment device 100.

In step S1170, the user of the responder device 1 performs a submission operation with respect to the intercommunication interface 1500.

In step S1180, an outward message is transmitted to the neighboring portable devices P, thereby interacting with a communication interface C (not shown) of the neighboring portable devices P.

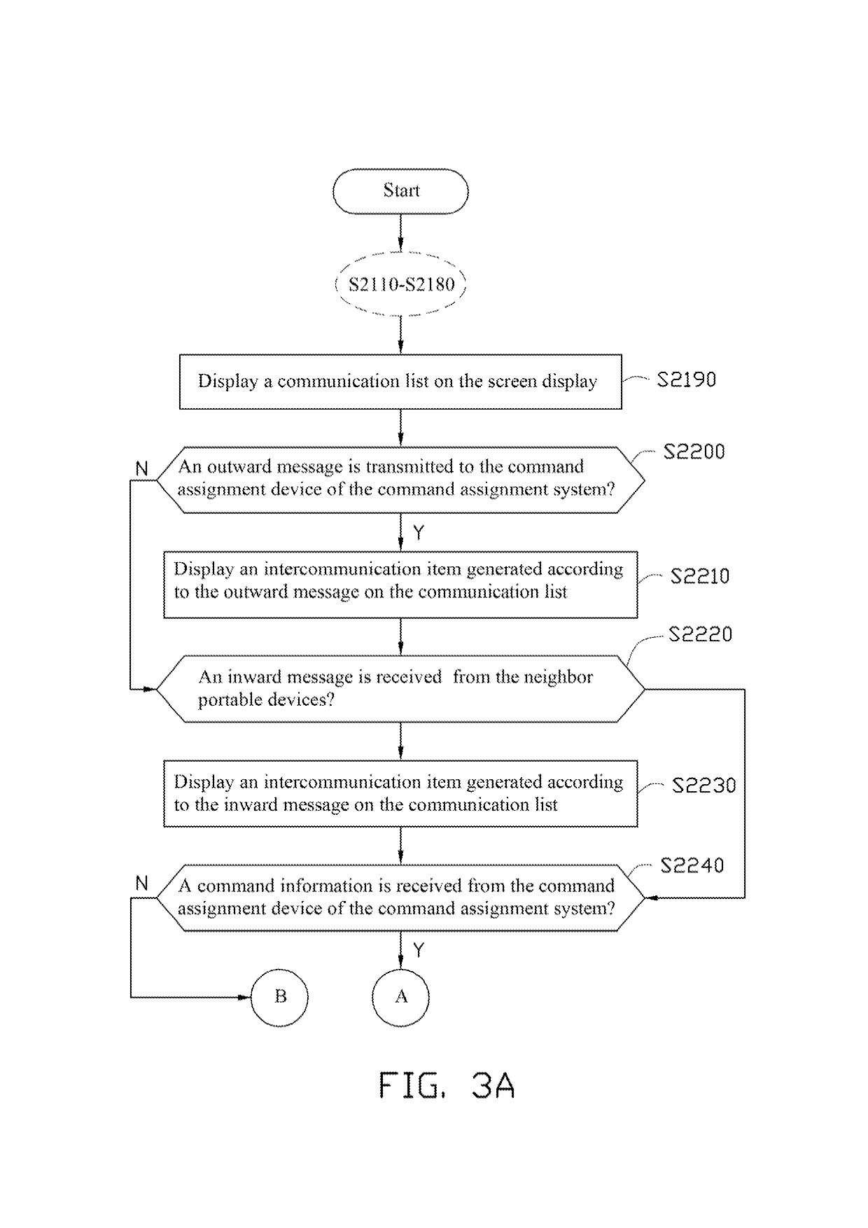

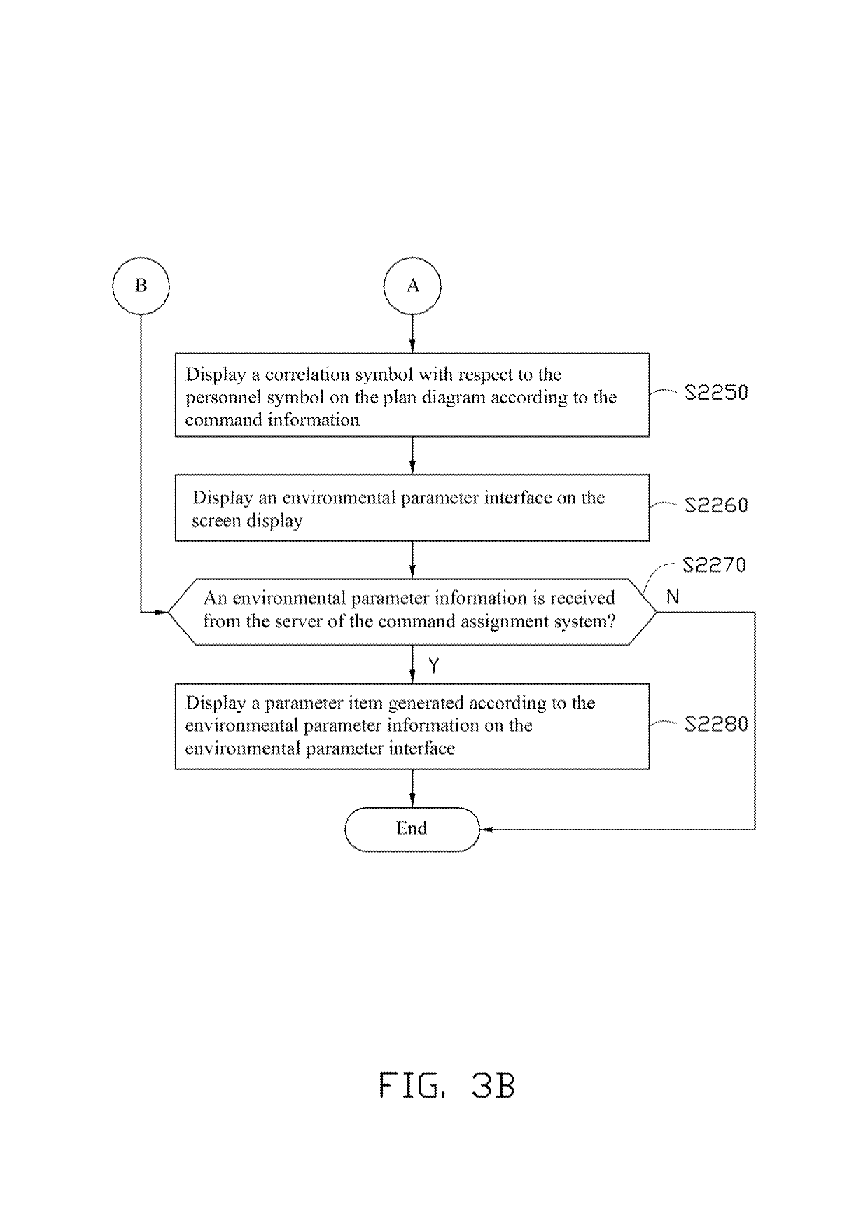

FIGS. 3A/3B is a flowchart of a second embodiment of a communication method implemented through the responder device 1 of FIG. 1. The communication method of the present disclosure is as follows. Depending on the embodiment, additional steps may be added, others removed, and the ordering of the steps may be changed.

Steps S2100 to S2180 are equivalent to S1110 to S1180, of FIG. 2, as detailed above, respectively, and will not be described below.

In step S2190, an intercommunication table 1510 (see FIG. 6) is displayed on the screen display 10.

In step S2200, a determination is made if there is an outward message transmitted to the command assignment device 100 of the command assignment system S. If the outward message exists, step S2210 is implemented; otherwise, step S2220 is implemented.

In step S2210, an intercommunication item generated according to the outward message is displayed on the intercommunication table 1510.

In step S2220, a determination is made if there is an inward message received from the neighboring portable devices P. If the inward message exists, step S2230 is implemented; otherwise, step S2240 is implemented.

In step S2230, an intercommunication item generated according to the inward message is displayed on the intercommunication table 1510.

In step S2240, a determination is made if a command information Ic (not shown) is received from the command assignment device 100 of the command assignment system S. If the command information Ic is received, step S2250 is implemented; otherwise, step S2260 is implemented.

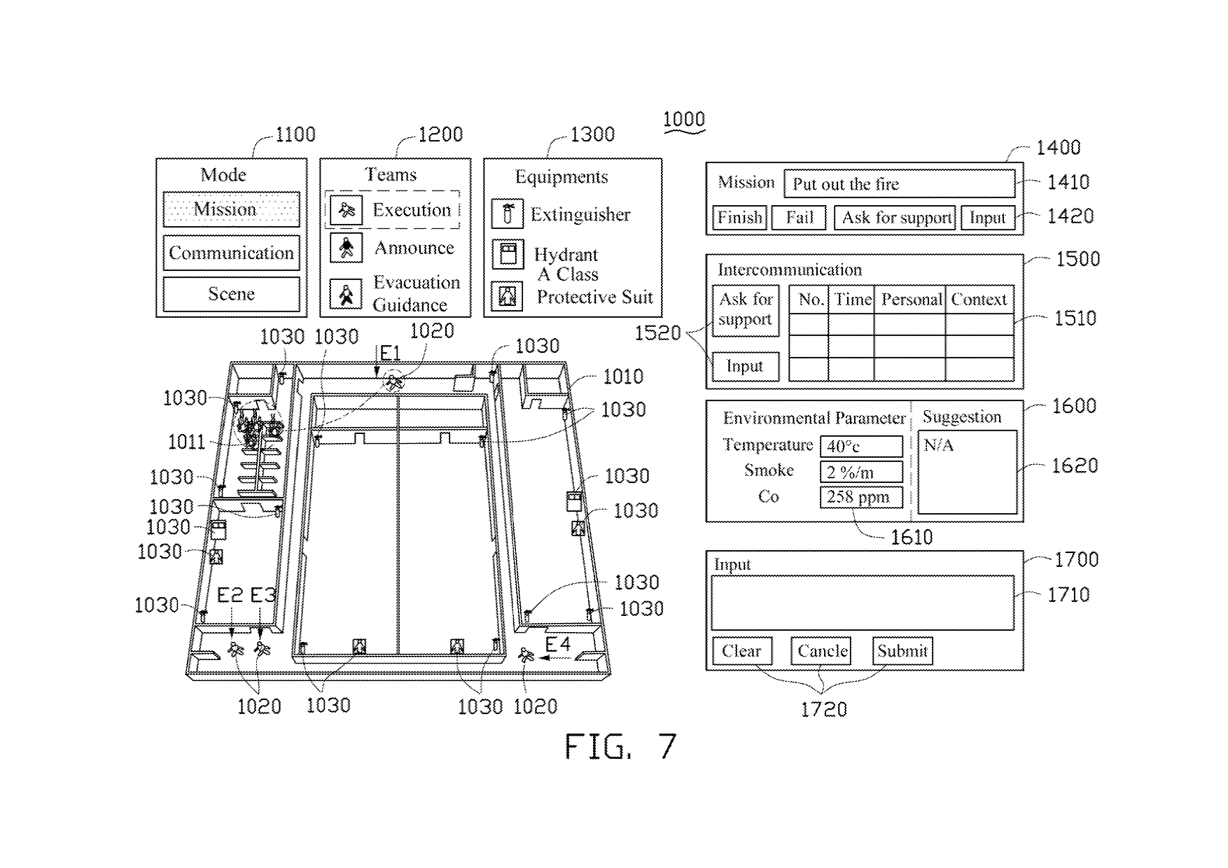

In step S2250, a correlation symbol 1040 (see FIG. 7) with respect to the personnel symbol 1020 is displayed on the floor plan diagram 1010 according to the command information Ic.

In step S2260, an environmental parameter interface 1600 (see FIG. 6) is displayed on the screen display.

In step S2270, a determination is made if an environmental parameter information is received from the server 200 of the command assignment system. If the environmental parameter information is received, step S2270 is implemented; otherwise, the method is terminated.

In step S2280, a parameter item 1610 (see FIG. 6) generated according to the environmental parameter information displayed on the environmental parameter interface 1600.

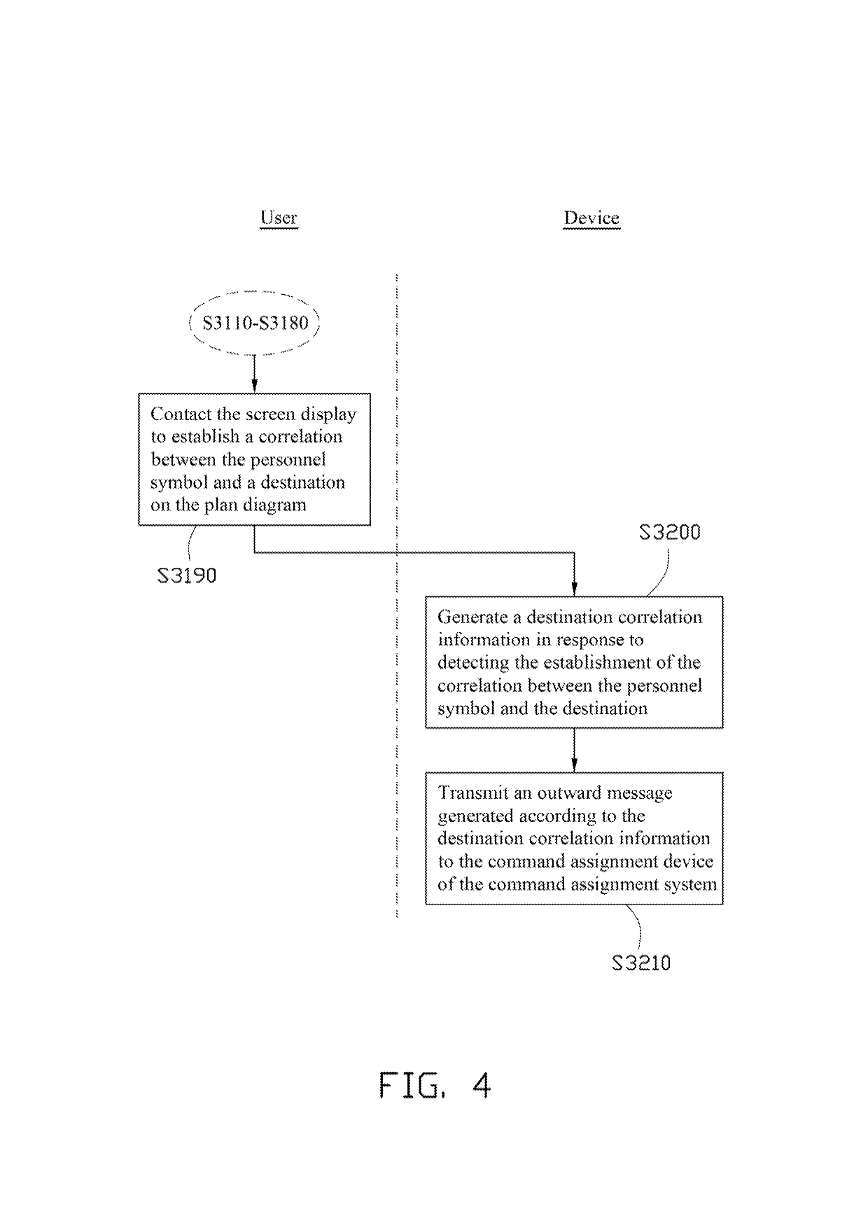

FIG. 4 is a flowchart of a third embodiment of a communication method implemented through the responder device 1 of FIG. 1. The communication method of the present disclosure is as follows. Depending on the embodiment, additional steps may be added, others removed, and the ordering of the steps may be changed.

Steps S3100 to S3180 are equivalent to S1110 to S1180, of FIG. 2, as detailed above, respectively, and will not be described below.

In step S3190, the screen display 10 receives an instruction from the user of the command assignment device 1 to establish a correlation between the personnel symbol 1020 and a destination 1011 (see FIG. 6) on the floor plan diagram 1010.

In step S3200, a destination correlation information Id (not shown) is generated as a response when the establishment of the correlation between the personnel symbol 1020 and the destination 1011 has occurred.

In step S3210, an outward message generated according to the destination correlation information Id is transmitted to neighboring portable devices P, thereby interacting with the communication interface C of the neighboring portable devices P.

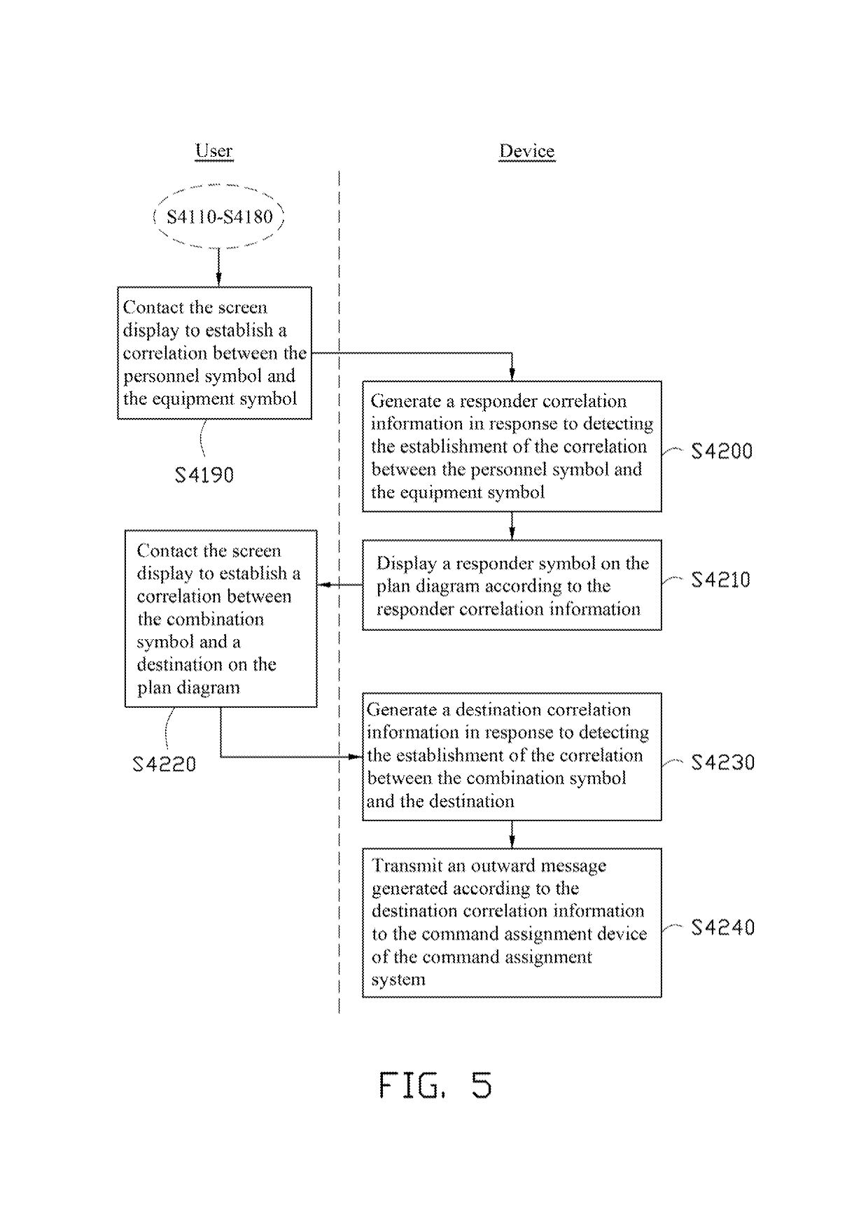

FIG. 5 is a flowchart of a fourth embodiment of a communication method implemented through the responder device 1 of FIG. 1. The communication method of the present disclosure is as follows. Depending on the embodiment, additional steps may be added, others removed, and the ordering of the steps may be changed.

Steps S4100 to S4180 are equivalent to S1110 to S1180, shown in FIG. 2, as detailed above, respectively, and will not be described below.

In step S4190, the screen display 10 receives an instruction from the user of the command assignment device 1 to establish a correlation between the personnel symbol 1020 and the equipment symbol 1030.

In step S4200, a responder correlation information Ir (not shown) is generated as a response when the establishment of the correlation between the personnel symbol 1020 and the equipment symbol 1030 has occurred.

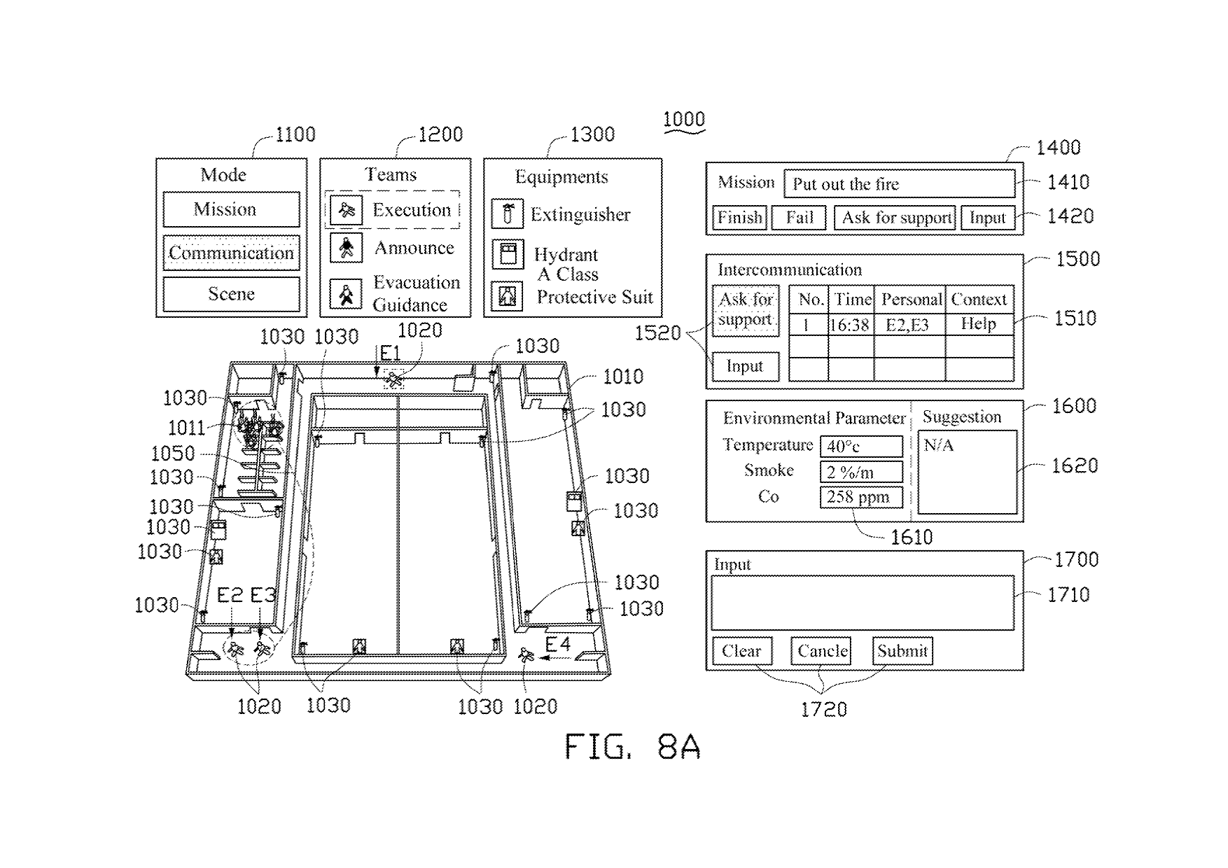

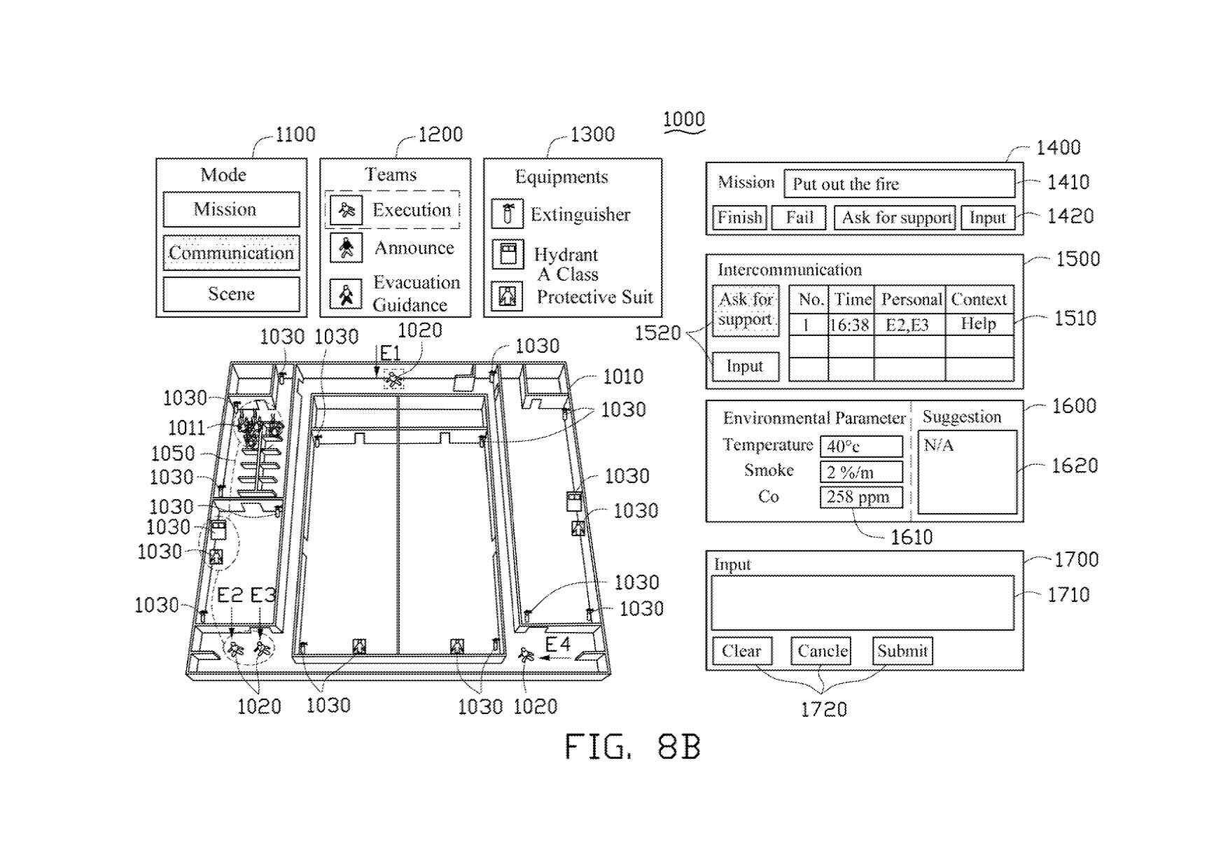

In step S4210, a combination symbol 1050 (see FIG. 8) is displayed on the floor plan diagram 1010 according to the responder correlation information Ir

In step S4220, the screen display 10 receives an instruction from the user of the command assignment device 1 to establish a correlation between the combination symbol 1050 and a destination 1011 (see FIG. 6) on the floor plan diagram 1010.

In step S4230, a destination correlation information Id (not shown) is generated as a response when the establishment of the correlation between the combination symbol 1050 and the destination 1011 has occurred.

In step S4240, an outward message generated according to the destination correlation information Id is transmitted to the neighboring portable devices P, thereby interacting with the communication interface C of the neighboring portable devices P.

FIG. 6 is a schematic view of an embodiment of a user interface 1000 implemented through the responder device 1 of FIG. 1. The user interface 1000 is a GUI displayed through the screen display 10 of the responder device 1 (see FIG. 1) and includes the floor plan diagram 1010, a mode list 1100, a team list 1200, an equipment list 1300, the report interface 1400, the intercommunication interface 1500, the environmental parameter interface 1600, and an input interface 1700. The mode list 1100 includes three buttons, which represent a mission mode, a communication mode, and a scene mode, which can be selected or changed by, for instance, making contact with the screen display 10 or by moving a cursor displayed on the screen display 10, to change the operation mode of the user interface 1000. In the illustrated embodiment, the team list 1200 includes three items representing the execution team, the announcement team, and the evacuation guidance team. Any or all of which can be selected or de-selected by, for instance, making contact with the screen display 10 or by moving a cursor displayed on the screen display 10, to show the particular team(s) selected on the floor plan diagram 1010. The equipment list 1300 includes three items representing fire extinguishers, water hydrants, protective suits which can be selected and de-selected by, for instance, making contact with the screen display 10 or by moving a cursor displayed on the screen display 10, to indicate the particular type(s) of equipment selected, and displayed as such on the floor plan diagram 1010.

The report interface 1400 includes a mission title item<<How about “Title”>>1410 for displaying a mission title. In addition, the report interface 1400 includes report buttons 1420 for transmitting a message for a mission corresponding to the mission name to the command assignment device 100 of the command assignment system S to interact with the command assignment interface A, of the command assignment device 100 displayed on the screen display 110 of the command assignment device 100. The report buttons 1420 include a finish button, a fail button, a support button, and an input button, which can be actuated to transmit the report message representing the achievement of the mission, the failure of the mission, calling for support, and a report with a context input by the user of the responder device 1, respectively, wherein the context of the report can be input through the input interface 1700 when the input button is actuated. The intercommunication interface 1500 includes an intercommunication table 1510 for displaying the intercommunications with the neighboring portable devices P and intercommunication buttons 1520 for transmitting an outward message to the neighboring portable devices P to interact with the communication interface C of the neighboring portable devices P. The intercommunication buttons 1520 include a support button and an input button, which can be actuated to transmit the outward message representing calling for support in the mission and an intercommunication with a context input by the user of the responder device 1, respectively, wherein the context of the intercommunication can be input through the input interface 1700 when the input button is actuated.

The environmental parameter interface 1600 includes parameter items 1610 for displaying environmental parameters of the particular scene, which the responder device 1 is located and a suggestion interface 1620 for displaying suggestions corresponding to the environmental parameters to the user of the responder device 1. In the illustrated embodiment, the environmental parameters may be sensor parameters received from stationary sensor installed at the particular scene or portable sensors located at, for example, the body of the user of the responder device 1 or the neighboring portable devices P. When the sensor parameter is not within a tolerable range, the responder device 1 provides an alarm via audio or visual means, thereby attracting the attention of the user of the responder device 1. For instance, the responder device 1 can provide the alarm on the screen display 10 or a speaker, while an area at the particular scene corresponding to the alarm is shown on the floor plan diagram 1010 through, for example, a symbol signifying the area. The sensor parameter can be, for example, temperature, humidity, acidic materials, base materials, electrical voltages and/or current, hazardous radioactive materials, or other environmental parameters. The input interface 1700 includes an input interface 1710 for inputting and function buttons 1720 for processing the context input to the input interface 1710. The function buttons 1720 include a clear button, a cancel button and a submit button, which can be actuated to clear the input context on the input interface 1710, cancel the input operation with respect to the input interface 1700, and finish the input, respectively.

The personnel symbol 1020 is displayed on the floor plan diagram 1010 according to the locations of the responder device 1 and the neighboring portable devices P, when the responder device 1 or the neighboring portable devices P are at the particular scene, wherein the personnel symbol 1020 is a graphical, interactive user-interface object-image such as an icon to represent the location of emergency personnel, which can be dragged or otherwise be moved on the screen display 10. The equipment symbol 1030 is displayed on the floor plan diagram 1010 according to the equipment location information 211, when the corresponding equipment is located at the particular scene, wherein the equipment symbol 1030 is a graphical, interactive user-interface object-image such as an icon representing the location of the equipment, which can be dragged or otherwise be moved on the screen display 10. In the illustrated embodiment, the destination 1011 is displayed according to one or more sensor signals received from the one or more sensors installed at the particular scene. In another embodiment, the destination 1011 can be manually designated by, for example, the user of the command assignment device 100 or the responder device 1.

FIG. 7 is a schematic view of an embodiment of a process of using the user interface 1000 of FIG. 6 in mission mode. In the mission mode, the user interface 1000 interacts with the command assignment interface A of the command assignment device 100. In the illustrated embodiment, a rectangle symbol is displayed to enclose the personnel symbol 1020 corresponding to the user of the responder device 1, thereby indicating the location of the user. The correlation symbol 1040 indicates a correlation between the personnel symbols 1020 and the destination 1011 on the floor plan diagram 1010 is displayed on the floor plan diagram 1010 according to the command information Ic received from the command assignment device 100 of the command assignment system S, thereby prompting the user of the responder device 1 about the context of a mission. The command information Ic may be generated according to the lines or traces drawn by the user of the command assignment device 100 on a floor plan diagram displayed on the screen display 110 of the command assignment device 100 through, for instance, making contact with the screen display 110 or by moving a cursor displayed on the screen display 110.

FIG. 8A is a schematic view of a first embodiment of a process of using the user interface 1000 of FIG. 6 in communication mode. Once a correlation between the personnel symbols 1020 and the destination 1011 on the floor plan diagram 1010 is established, the destination correlation information Id is generated. A combination symbol 1050, which is a GUI object-image representing the correlation of the personnel symbols 1020 and the destination 1011 may be displayed according to the destination correlation information Id, and an item of the intercommunication table 1510 is produced according to the destination correlation information Id. The outward message including the destination correlation information Id is transmitted to the neighboring portable devices P through operating the intercommunication interface 1500.

FIG. 8B is a schematic view of a second embodiment of a process of using the user interface 1000 of FIG. 6 in communication mode. Once a correlation between two of the personnel symbols 1020 and two of the equipment symbols 1030 is established, the responder correlation information Ir is generated, and a graphical, interactive user-interface object-image correlating the two personnel symbols 1020 and the two equipment symbols 1030 is displayed according to the responder correlation information Ir. Once a correlation between the user-interface object-image (which correlated the two personnel symbols 1020 and the two equipment symbols 1030) and the destination 1011 on the floor plan diagram 1010 is established, the destination correlation information Id is generated. A combination symbol 1050, which is a GUI object-image, is displayed according to the destination correlation information Id to signify the correlation of the personnel symbols 1020, the equipment symbols 1030, and the destination 1011, and an item of the intercommunication table 1510 is produced according to the destination correlation information Id.

In the illustrated embodiment, a graphical, interactive user-interface object-image enclosing the two personnel symbols 1020 is produced and displayed when the two personnel symbols 1020 are together, and a graphical, interactive user-interface object-image enclosing the two equipment symbols 1030 is produced and displayed when the two equipment symbols 1030 are together, for instance, making contact with the screen display 10 or by moving a cursor displayed on the screen display 10. The correlation between the two personnel symbols 1020 and the two equipment symbols 1030 can be established by, for instance, moving the user-interface object-image enclosing the personnel symbols 1020 to the equipment symbols 1030 to enclose them, or by moving the user-interface object-image enclosing the equipment symbols 1030 to the personnel symbols 1020. The correlation between the user-interface object-image correlating the two personnel symbols 1020 and the two equipment symbols 1030 as well as the destination 1011 can also be established by, for instance, moving the relevant user-interface object-image(s) to the destination 1011.

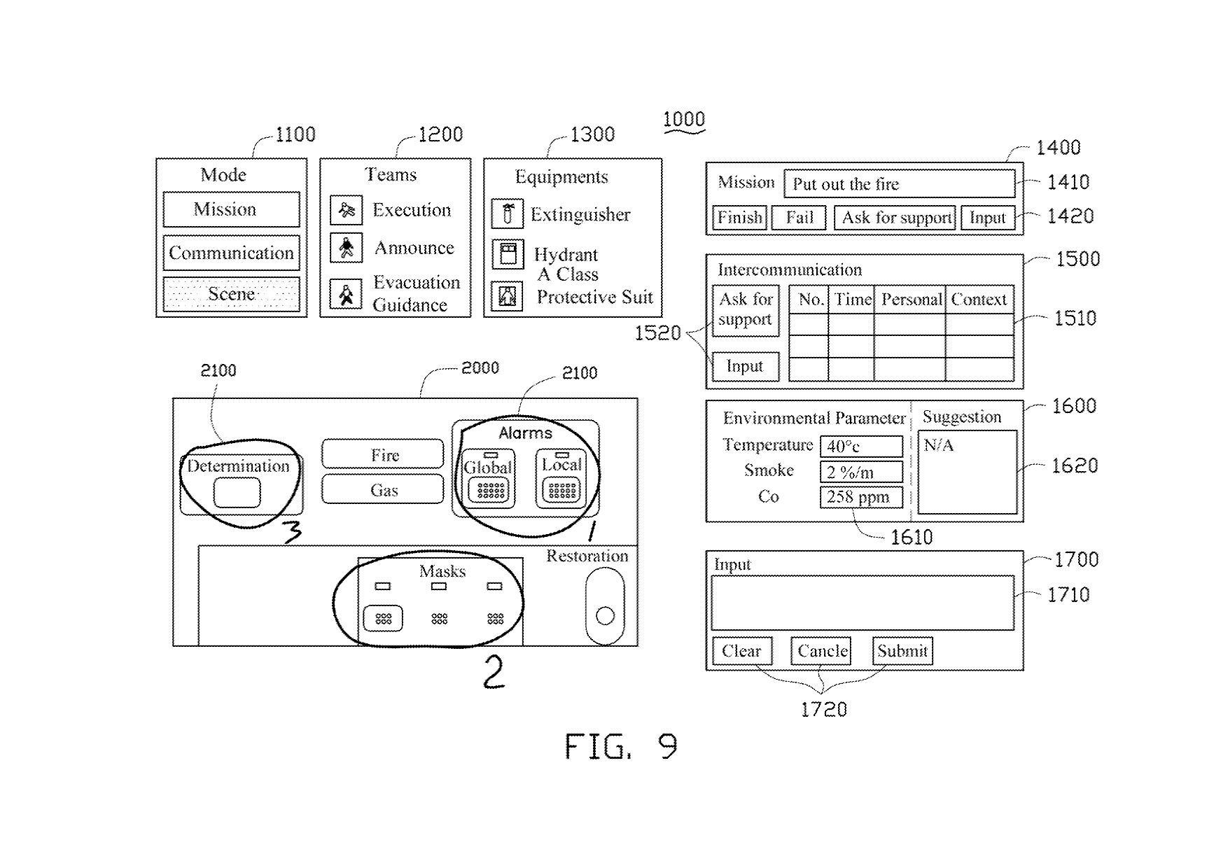

FIG. 9 is a schematic view of an embodiment of a process of using the user interface 1000 of FIG. 6 in scene mode. In the scene mode, a scene image 2000 captured by the responder device 1 is displayed on the screen display 10 and transmitted to the command assignment device 100. A demonstration information is generated according to the lines or traces drawn by the user of the command assignment device 100 (or the responder device 1) on the scene image 2000 through, for instance, making contact with the screen display 110 (or the screen display 10) or by moving a cursor displayed on the screen display 110 (or the screen display 10), and the demonstration information is transmitted to the responder device 1 (or command assignment device 100), thereby demonstrating to the user of the responder device 1 (or command assignment device 100). The responder device 1 (or the responder device 1) can show the scene image 2000 and sketches 2100 generated so as to reveal and repeat the lines or traces drawn on the scene image 2000 displayed on the screen display 110 of the command assignment device 100 (or the screen display 10 of the responder device 1) in real time according to the demonstration information. In the illustrated embodiment, steps to operate a fire alarm control panel are shown by the sketches 2100.

The communication device and the communication method provide a very useful GUI whereby a responder at the scene of an emergency can communicate with a commander. Since commands are shown graphically, the emergency responders can fully comprehend and act on the commands even if they are unfamiliar with the scene, while the commander can issue the commands precisely and in a timely fashion.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A communication method, comprising:
a portable device with a screen display, wherein the portable device is capable of interacting with a command assignment system providing one or more equipment location information of one or more equipment located in a scene;
displaying a floor plan diagram corresponding to the scene on the screen display;
displaying one or more personnel symbols on the floor plan diagram according to the location of the portable device;
receiving the one or more equipment location information from the command assignment system;
displaying one or more equipment symbols on the floor plan diagram according to the one or more equipment location information;
displaying a report interface on the screen display;
displaying an intercommunication interface on the screen display;
in response to detecting a submission operation with respect to the report interface, transmitting a report message to the command assignment system to interact with a command assignment interface of the command assignment system; and
in response to detecting a submission operation with respect to the intercommunication interface, transmitting an outward message to one or more neighboring portable devices to interact with a communication interface of the one or more neighboring portable devices.

2. The communication method of claim 1, further comprising:
displaying a correlation symbol with respect to the one or more personnel symbols on the floor plan diagram according to a command information received from the command assignment system.

3. The communication method of claim 1, further comprising:
displaying an environmental parameter interface on the screen display according to an environmental parameter information received from the command assignment system.

4. The communication method of claim 1, further comprising:
displaying an intercommunication table comprising one or more communication items generated according to the outward message or an inward message received from the command assignment system.

5. The communication method of claim 1, further comprising:
generating a destination correlation information in response to detecting a correlation operation between the one or more personnel symbols and a destination on the floor plan diagram.

6. The communication method of claim 1, further comprising:
generating a responder correlation information in response to detecting a correlation operation between the one or more personnel symbols and the one or more equipment symbols; and
displaying a responder symbol on the floor plan diagram according to the responder correlation information.

7. The communication method of claim 1, wherein each of the steps is an instruction stored in a computer readable storage medium.

8. A graphical user interface of a portable device with a screen display, the portable device being capable of interacting with a command assignment system providing one or more equipment location information of one or more equipment located in a scene, the graphical user interface comprising:
a floor plan diagram displayed corresponding to the scene on the screen display;
one or more personnel symbols displayed on the floor plan diagram according to the location of the portable device;
one or more equipment symbols displayed on the floor plan diagram according to the one or more equipment location information received from the command assignment system;
a report interface displayed on the screen display; and
an intercommunication interface displayed on the screen display;
wherein a submission operation can be performed with respect to the report interface, such that the portable device transmits a report message to the command assignment system to interact with a command assignment interface of the command assignment system when a submission operation with respect to the report interface is detected by the portable device, a submission operation can be performed with respect to the intercommunication interface, such that the portable device transmits an outward message to one or more neighboring portable devices to interact with a communication interface of the one or more neighboring portable devices when a submission operation with respect to the intercommunication interface is detected by the portable device.

9. The graphical user interface of claim 8, further comprising a correlation symbol with respect to the one or more personnel symbols displayed on the floor plan diagram according to a command information received from the command assignment system

10. The graphical user interface of claim 8, further comprising an environmental parameter interface displayed on the screen display according to an environmental parameter information received from the command assignment system.

11. The graphical user interface of claim 8, further comprising an intercommunication table, wherein the intercommunication table comprises one or more intercommunication items generated according to the outward message or an inward message received from the command assignment system.

12. The graphical user interface of claim 8, further comprising a responder symbol displayed on the floor plan diagram, wherein the responder symbol is displayed according to a responder correlation information generated in response to detecting a correlation operation between the one or more personnel symbols and the one or more equipment symbols by the portable device.

13. The graphical user interface of claim 8, wherein a correlation operation can be performed between the one or more personnel symbols and a destination on the floor plan diagram, such that the portable device generates a destination correlation information in response to detecting a correlation operation between the one or more personnel symbols and the destination on the floor plan diagram.

14. A communication device interacting with a command assignment system providing one or more equipment location information of one or more equipment located in a scene, comprising:
a screen display;
a processing unit;
a storage unit; and
one or more software modules stored in the storage unit and configured for execution by the processing unit, the one or more software modules comprising instructions:
to display a floor plan diagram corresponding to the scene on the screen display;
to display one or more personnel symbols on the floor plan diagram according to the location of the communication device;
to receive the one or more equipment location information from the command assignment system;
to display one or more equipment symbols on the floor plan diagram according to the one or more equipment location information;
to display a report interface on the screen display;
to transmit a report message to the command assignment system to interact with a command assignment interface of the command assignment system in response to detecting a submission operation with respect to the report interface;
to display an intercommunication interface on the screen display; and
to transmit an outward message to one or more neighboring portable devices to interact with a communication interface of the one or more neighboring communication devices in response to detecting a submission operation with respect to the intercommunication interface.

15. The communication device of claim 14, the one or more software modules further comprising instructions:
to display a correlation symbol with respect to the one or more personnel symbols on the floor plan diagram according to a command information received from the command assignment system.

16. The communication device of claim 14, the one or more software modules further comprising instructions:
to display an environmental parameter interface on the screen display according to an environmental parameter information received from the command assignment system.

17. The communication device of claim 14, the one or more software modules further comprising instructions:
to display an intercommunication table comprising one or more intercommunication items generated according to the outward message or an inward message received from the command assignment system.

18. The communication device of claim 14, the one or more software modules further comprising instructions:
to generate a destination correlation information in response to detecting a correlation operation between the one or more personnel symbols and a destination on the floor plan diagram.

19. The communication device of claim 14, the one or more software modules further comprising instructions:
to generate a responder correlation information in response to detecting a correlation operation between the one or more personnel symbols and the one or more equipment symbols; and
to display a responder symbol on the floor plan diagram according to the responder correlation information.

20. The communication device of claim 14, wherein the screen display is a touch-sensitive display, the one or more personnel symbols is a graphical, interactive user-interface object-image moved in accordance with a contact with the touch-sensitive display.
